(19) United States
(12) Patent Application Publication
(10) Pub. No.: US 2024/0332848 A1
(43) Pub. Date: Oct. 3, 2024

(54) Electrical Connector Housing and Electrical Connector

(71) Applicants: Tyco Electronics (Suzhou) Ltd., Suzhou City (CN); Tyco Electronics (Shanghai) Co., Ltd., Shanghai (CN)

(72) Inventors: Kang Zhou, Suzhou (CN); Jun Zong, Shanghai (CN); Tao (Thomson) Dong, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 18/618,162

(22) Filed: Mar. 27, 2024

(30) Foreign Application Priority Data
Mar. 27, 2023 (CN) 202320628397.3

(51) Int. Cl. H01R 13/506; H01R 12/69

(52) U.S. Cl. CPC H01R 13/506; H01R 12/69

(57) ABSTRACT

An electrical connector housing includes a first housing part, a second housing part, and an elastic connection part. At least one of the first housing part or the second housing part defines a receiving slot adapted or sized to receive a plurality of connection terminals and a circuit board. Respective one ends of the first housing part and the second housing part are connected together via the elastic connection part. The elastic connection part is adapted such that respective other ends of the first housing part and the second housing part distal from the elastic connection part are separated from each other under an elastic action of the elastic connection part, maintaining the receiving slot in an open state or position.

### CROSS-REFERENCE TO RELATED APPLICATION

This application claims the benefit of Chinese Patent Application No. CN 202320628397.3 filed on Mar. 27, 2023, in the China National Intellectual Property Administration, the whole disclosure of which is incorporated herein by reference.

### FIELD OF THE INVENTION

Embodiments of the present disclosure generally relate to the technical field of electrical connectors, and in particular, to an electrical connector housing and an electrical connector.

### BACKGROUND

In the applications of existing electrical connectors for flexible printed circuit boards, connection terminals are pre-installed on the flexible printed circuit board to achieve physical and electrical connections between electrical contacts on the flexible printed circuit board and the connection terminals, and to form an assembly of the flexible printed circuit board and the connection terminals. Then, the assembly of the flexible printed circuit board and the connection terminals is inserted into a pocket of a housing of the electrical connector as a whole to form a complete electrical connector for the flexible printed circuit board.

In practice, the physical and electrical connections between the electrical contacts on the flexible printed circuit board and the connection terminals are achieved by crimping. As a result, due to the large number of the connection terminals and the influence of the crimped position, during the process of inserting the assembly of the flexible printed circuit board and the connection terminals into the pocket of the electrical connector housing, the accumulated friction force between elastic sheets of the connection terminals themselves and the pocket of the housing made of plastic is larger. Thus, an insertion force required to fully insert the assembly into the pocket of the electrical connector housing is relatively large. Moreover, the flexible characteristics of the circuit board also make it difficult for the assembly to be inserted into the pocket of the electrical connector housing, further increasing the difficulty of insertion. In addition, the insertion method of the assembly can easily cause damage to copper foils of crimping portions of the connection terminals, which are not visible after insertion and thereby posing a serious quality risk.

Moreover, in the related art, the electrical connector housing has poor tolerance for the adhesive dispensing in the puncturing and crimping region of the flexible circuit board, and has strict specification requirements for the thickness of adhesive dispensing. Once this dispensing thickness exceeds the specification requirements, the flexible circuit board will be difficult to be inserted. In addition, in the related art, there is still a problem of inaccurate alignment between the connection terminals and through holes of the housing when the assembly of the flexible printed circuit board and the connection terminals is inserted into the pocket of the electrical connector housing.

### SUMMARY

According to an embodiment of the present disclosure, an electrical connector housing includes a first housing part, a second housing part, and an elastic connection part. At least one of the first housing part or the second housing part defines a receiving slot adapted or sized to receive a plurality of connection terminals and a circuit board. Respective one ends of the first housing part and the second housing part are connected together via the elastic connection part. The elastic connection part is adapted such that respective other ends of the first housing part and the second housing part distal from the elastic connection part are separated from each other under an elastic action of the elastic connection part such that the receiving slot is initially maintained open.

### BRIEF DESCRIPTION OF THE DRAWINGS

The invention will now be described by way of example with reference to the accompanying Figures, of which:

FIG. 1 shows a schematic structural view of an electrical connector housing according to an exemplary embodiment of the present disclosure, wherein a receiving slot is initially opened;

FIG. 2 shows a schematic structural view of the electrical connector according to the exemplary embodiment of the present disclosure, wherein the receiving slot of the electrical connector housing is initially opened, and an assembly of connection terminals and a circuit board has been placed into the receiving slot;

FIG. 3 shows a schematic structural view of the electrical connector according to the exemplary embodiment of the present disclosure, wherein the receiving slot of the electrical connector housing is kept closed and an assembly of the connection terminals and the circuit board has been locked in the receiving slot; and

FIG. 4 is a schematic sectional view of the electrical connector shown in FIG. 3.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to one embodiment of the present disclosure, an electrical connector housing includes a first housing part, a second housing part, and an elastic connection part. At least one of the first housing part or the second housing part defines a receiving slot for receiving a plurality of connection terminals and a circuit board. Respective ends of the first housing part and the second housing part are connected together (e.g., hingedly connected) via the elastic connection part. The elastic connection part is adapted such that respective other ends of the first housing part and the second housing part away from the elastic connection part are separated from each other under the elastic action of the elastic connection, maintaining the receiving slot in an open position or state.

According to another embodiment of the present disclosure an electrical connector includes the abovementioned electrical connector housing, a plurality of connection terminals, and a circuit board. The plurality of connection terminals and the circuit board are connected together and placed in the initially opened receiving slot of the electrical connector housing.

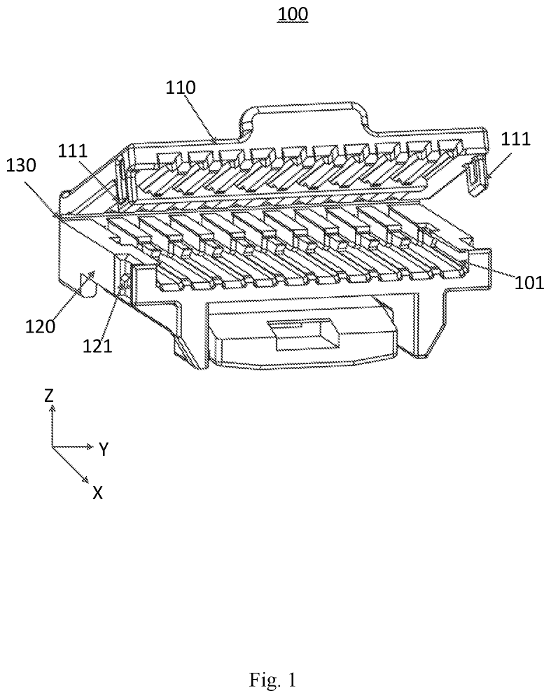

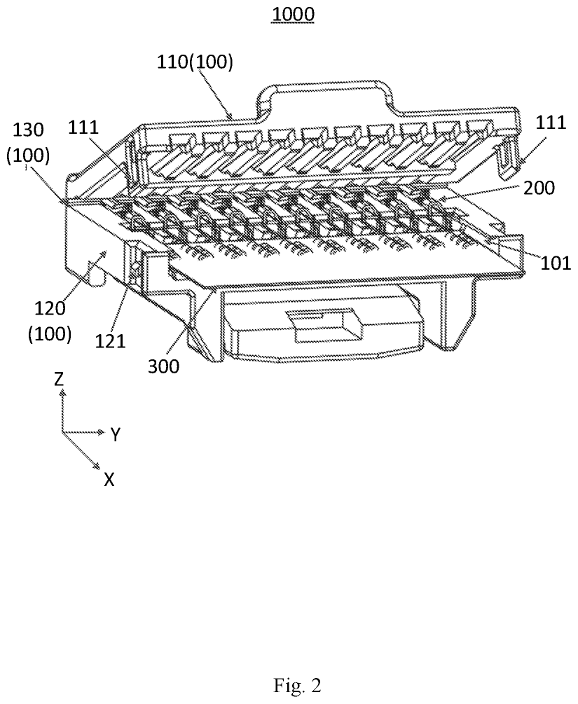

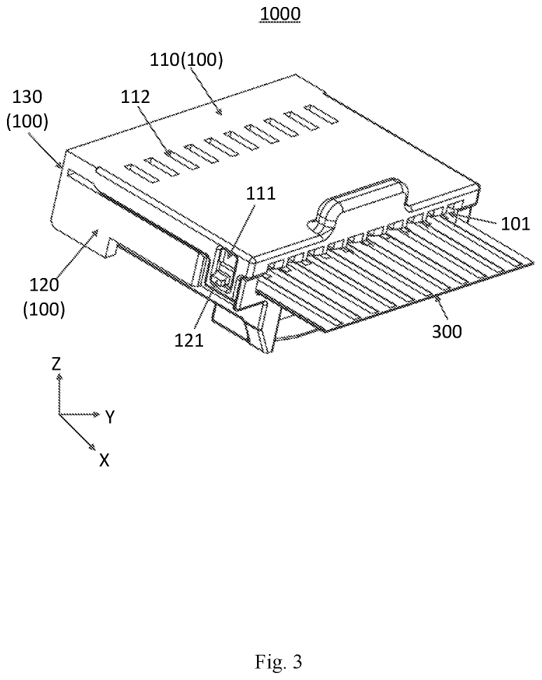

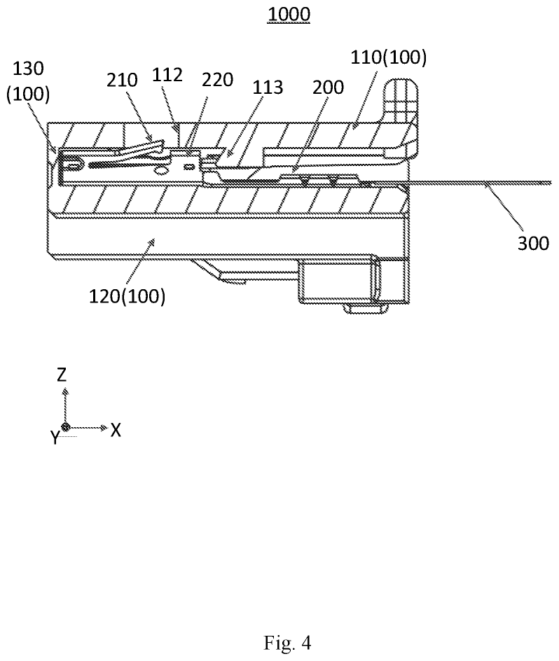

FIG. 1 shows a schematic structural view of an electrical connector housing according to an exemplary embodiment of the present disclosure, wherein a receiving slot is initially opened. FIGS. 2-4 show schematic structural views of the electrical connector according to the exemplary embodiment of the present disclosure, respectively. Specifically, FIG. 2 shows the receiving slot of the electrical connector housing which is initially opened and an assembly of connection terminals and a circuit board which has been placed in the receiving slot. FIG. 3 shows the receiving slot of the electrical connector housing which is kept closed and the assembly of the connection terminals and the circuit board which has been locked in the receiving slot. FIG. 4 is a schematic sectional view of the electrical connector shown in FIG. 3, wherein the receiving slot of the electrical connector housing which is kept closed and the assembly of the connection terminals and the circuit board has been locked in the receiving slot.

In the description of exemplary embodiments shown in FIGS. 1-4 herein, for ease of explanation and illustration, a longitudinal extension direction of a single connection terminal 200 placed into an electrical connector housing 100 is defined as a first direction X, a direction along which a plurality of connection terminals 200 are arranged side by side is defined as a second direction Y, and a direction perpendicular to both the first direction X and the second direction Y is defined as a third direction Z.

Referring to FIG. 1, according to an embodiment of the present disclosure, the electrical connector housing 100 includes a first housing part 110, a second housing part 120, and an elastic connection part 130 (e.g., a living hinge). At least one (for example, the first housing part 110 in the embodiment shown in FIG. 1) of the first housing part 110 and the second housing part 120 defines a receiving slot 101 for receiving a plurality of connection terminals 200 and a circuit board 300. See FIGS. 2-4. Respective one ends of the first housing part 110 and the second housing part 120 are hingedly connected together via the elastic connection part 130.

Preferably, the first housing part 110 and the second housing part 120 are integrally formed with the elastic connection part 130. For example, in the illustrated embodiment, the first housing part 110, the second housing part 120, and the elastic connection part 130 may be made by integrally-formed from plastic material with certain elastic properties. In another example, the first housing part 110 and the second housing part 120 are connected together by the elastic connection part, such as an elastic sheet, and the receiving slot is kept initially open by the elastic action of the elastic sheet. According to the embodiment of the present disclosure, the elastic connection part 130 is adapted such that the respective other ends of the first housing part 110 and the second housing part 120 away from the elastic connection part 130 are moved away from each other under the elastic action of the elastic connection part 130, so as to keep the receiving slot 101 initially open in a resting state of the first housing part 110 and the second housing part 120.

Furthermore, as shown in FIG. 1, the first housing part 110 is provided with a first engagement portion 111, and the second housing part 120 is provided with a second engagement portion 121. The first engagement portion 111 and the second engagement portion 121 are configured to be engaged with each other when the first housing part 110 and the second housing part 120 are close to each other, so that the receiving slot 101 is kept closed. The “closed” described herein may refer to the restoration of the electrical connector housing 100, along with the receiving slot 101 therein, to the same conventional state as the integrated housing and pocket thereof in the related art. That is to say, the initial state of the electrical connector housing 100 provided by the present disclosure is the respective other ends of the first housing part 110 and the second housing part 120 away from the elastic connection part 130 are moved away from each other under the elastic action of the elastic connection part 130, and the receiving slot 101 is then in an open or opened state. The respective other ends of the first housing part 110 and the second housing part 120 away from the elastic connection part 130 overcome the elastic action of the elastic connection part 130 and move toward each other. The receiving slot 101 is then in a closed state, which is equivalent to the conventional state in the relate art.

According to the embodiments of the present disclosure, the elastic connection part 130 has a length which is the same as those of the corresponding end sides of the first housing part 110 and the second housing part 120, or which may also be less than or greater than those of the corresponding end sides of the first housing part 110 and the second housing part 120. According to the embodiments of the present disclosure, the first housing part 110 and the second housing part 120 of the electrical connector housing 100 is kept initially open under the elastic action of the elastic connection part 130. By adopting a split design of the electrical connector housing 100 in which the electrical connector housing 100 can be opened to expose the receiving slot 101, for example, as shown in FIG. 2, when the receiving slot 101 of the electrical connector housing 100 is initially opened, an assembly of the connection terminals 200 and the circuit board 300 (the “assembly” described herein may refer to an integral part formed after the connection terminals 200 and the circuit board 300 are previously connected together by soldering, etc.) can be easily placed into the receiving slot 101. That is, the connection terminals 200 or the circuit board 300 or the assembly of the connection terminals 200 and the flexible circuit board 300 can be placed into the receiving slot 101 of the electrical connector housing 100 with application of only a small external force or even no external force. This fundamentally overcomes various defects caused by the insertion method of the assembly adopted in the related art.

In the exemplary embodiment shown in FIG. 1, the first engagement portion 111 and the second engagement portion 121 are engaged in a snap-fit manner. One (in the exemplary embodiment shown, the second engagement portion 121) of the first engagement portion 111 and the second engagement portion 121 is a protruding block, and the other (in the illustrated exemplary embodiment, the first engagement portion 111) of the first engagement portion 111 and the second engagement portion 121 is an elastic piece with an opening capable of accommodating the protruding block. In other embodiments of the present disclosure, the first engagement portion 111 and the second engagement portion 121 can be engaged in any other suitable manner of fastening fit (for example, one of the first engagement portion 111 and the second engagement portion 121 is an insert, and the other of the first engagement portion 111 and the second engagement portion 121 has a hole being capable of accommodating the insert), as long as the receiving slot 101 can be kept closed when the first housing part and the second housing part are close to each other.

Specifically, according to the exemplary embodiments of the present disclosure, as shown in FIG. 1, the first housing part 110 is provided with the first engagement portion 111 on both sides of the receiving slot 101, respectively. The second housing part 120 is correspondingly provided with the second engagement portions 121 on both sides of the receiving slot 101, respectively. Preferably, the first engagement portion 111 is arranged near an entry of the receiving slot 101, and the second engagement portion 121 is arranged near the entry of the receiving slot 101. For example, as shown in FIG. 1, the first engagement portion 111 is arranged on both sides of the receiving slot 101 of the first housing part 110 along the second direction Y, respectively. The second engagement portion 121 is correspondingly arranged on both sides of the receiving slot 101 of the second housing part 120 along the second direction Y, respectively. Moreover, each first engagement portion 111 and each second engagement portion 121 are both arranged near the entry of the receiving slot 101 along the first direction X. With this configuration, it is beneficial to firmly keep the receiving slot 101 closed when the first housing part and the second housing part are close to each other, or in an engaged position or state, as shown in FIG. 3.

As shown in FIG. 1, the first engagement portion 111 is integrally formed with the first housing part 110, and the second engagement portion 121 is integrally formed with the second housing part 120. For example, preferably, the engagement portion 111, 121, together with the housing part 110, 120, and the elastic connection part 130, may be integrally formed from plastic material.

According to the present disclosure, any one of the first housing part 110 and the second housing part 120 relative to the housing part provided with the receiving slot 101 is formed with a locking block 113 extending into the receiving slot 101. The locking block 113 is configured to abut against the connection terminal 200 placed into the receiving slot 101. Specifically, according to the exemplary embodiment of the present disclosure, as shown in FIG. 4, the first housing part 110 may be formed with the locking block 113 extending into the receiving slot 101. The locking block 113 is adapted to abut against the connection terminal 200 placed into the receiving slot 101. More specifically, for example, the locking block 113 is configured to abut against a crimping portion 220 of the connection terminal 200 placed into the receiving slot 101. When the receiving slot 101 is kept closed, an end face of the crimping portion 220 of the connection terminal 200 abuts against the locking block 113, thereby effectively locking the assembly of the connection terminals 200 and the circuit board 300 in an appropriate position within the receiving slot 101.

Any one of the first housing part 110 and the second housing part 120 relative to the housing part provided with the receiving slot 101 is formed with a locking notch 112. The locking notch 112 is configured to allow the connection terminal 200 placed into to extend thereinto and to abut against the connection terminal 200. Specifically, according to the exemplary embodiment of the present disclosure, as shown in FIG. 4, the first housing part 110 may also be formed with a locking notch 112 configured to allow the connection terminal 200 placed into the receiving slot 101 to extend thereinto and to abut against the connection terminal 200.

More specifically, for example, as shown in FIG. 4, the locking notch 112 is configured to allow an elastic piece portion 210 of the connection terminal 200 placed into the receiving slot 101 to extend thereinto and to abut against the elastic sheet portion 210. For example, as shown in FIG. 4, when the receiving slot 101 is kept closed, at least a section of the elastic piece portion 210 of the connection terminal 200 extends into the locking notch 112, and an end of the elastic piece portion 210 abuts against a wall of the locking notch 112. This further locks the assembly of the connection terminals 200 and the circuit board 300 in the appropriate position within the receiving slot 101. It should be noted that regarding the abovementioned locking notch 112, in the embodiment shown in the figures, the locking notch 112 may penetrate through the first housing part 110. In another embodiment not illustrated, the locking notch may be a blind-hole formed in the inner surface of the first housing part 110. That is, it does not penetrate through the first housing part 110.

Therefore, with the electrical connector housing provided by the embodiments of the present disclosure, when the receiving slot is kept closed, the electrical connector housing can effectively and accurately lock the assembly of the connection terminals and the circuit board in the receiving slot of the electrical connector housing. At the same time, accurate alignment between the connecting terminals and the through holes of the housing can be ensured. Moreover, the assembly of the connection terminals and the flexible circuit board is placed and locked in the electrical connector housing, preventing damage to the adhesive dispensing of the crimping portion of the connection terminal. As a result, the tolerance for the adhesive dispensing of the crimping portion of the connection terminals is improved, the thickness requirement is no longer strict, and the overall pressure resistance of the electrical connector is significantly improved.

According to the embodiments of the present disclosure, as shown in FIGS. 2-4, an electrical connector 1000 includes an electrical connector housing 100 according to any one of the aforementioned embodiments, a plurality of connection terminals 200, and a circuit board 300. The plurality of connection terminals 200 and the circuit board 300 are connected together and placed into the receiving slot 101 of the electrical connector housing 100.

As shown in FIG. 2, during the installation or assembling process of the electrical connector, when the receiving slot 101 of the electrical connector housing 100 is initially opened, the assembly of the connection terminals 200 and the circuit board 300 can be easily placed into the receiving slot 101. Specifically, in the exemplary embodiments shown in FIGS. 2-4, the plurality of connection terminals 200 are arranged side by side in the electrical connector housing 100 along the second direction Y, and more specifically, arranged side by side in the second housing part 120.

According to the exemplary embodiments of the present disclosure, as shown in FIGS. 3 and 4, each connection terminal 200 may include a crimping portion 220. The first housing part 110 of the electrical connector housing 100 is formed with a locking block 113 extending into the receiving slot 101. For example, as shown in FIG. 4, after the installation or assembling of the electrical connector is completed, the receiving slot 101 is kept closed, and an end face of the crimping portion 220 of the connection terminal 200 abuts against the locking block 113. This effectively locks the assembly of the connection terminals 200 and the circuit board 300 in an appropriate position within the receiving slot 101.

Each connection terminal 200 may further include an elastic portion 210. The first housing part 110 is formed with a locking notch 112. For example, as shown in FIG. 4, after the installation or assembling of the electrical connector is completed, the receiving slot 101 is kept closed. At least a section of the elastic sheet portion 210 of the connection terminal 200 extends into the locking notch 112, and an end of the elastic sheet portion 210 abuts against the locking notch 112, thereby further locking the assembly of the connection terminals 200 and the circuit board 300 in the appropriate position within the receiving slot 101. Accordingly, with the electrical connector provided by the embodiments of the present disclosure, after the installation or assembling of the electrical connector is completed, the receiving slot of the electrical connector housing is kept closed, and the assembly of the connection terminals 200 and the circuit board 300 can be effectively locked in the receiving slot of the electrical connector housing.

According to the exemplary embodiments of the present disclosure, as shown in FIGS. 2-4, the plurality of connection terminals 200 are adapted to be engaged with the circuit board 300 in a crimping manner. The circuit board 300 described herein is preferably a flexible printed circuit board. In this way, with the electrical connector provided by the embodiments of the present disclosure, the assembly of the connection terminals and the flexible printed circuit board is placed and locked in the electrical connector housing, thus preventing damage to the adhesive dispensing of the crimping portion of the connecting terminal. Resultingly, tolerance for the adhesive dispensing of the crimping portion of the connection terminal is improved, the thickness requirement is no longer strict, and the overall pressure resistance of the electrical connector is significantly improved.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An electrical connector housing, comprising:
a first housing part;
a second housing part, at least one of the first housing part and the second housing part defining a receiving slot adapted to receive a plurality of connection terminals and a circuit board; and
an elastic connection part connecting respective first ends of the first housing part and the second housing part, the elastic connection part adapted such that respective second ends of the first housing part and the second housing part opposite to the elastic connection part are separated from each other under an elastic action of the elastic connection part and the receiving slot is initially maintained in an open state.

2. The electrical connector housing according to claim 1, wherein:
the first housing part includes a first engagement portion;
the second housing part includes a second engagement portion; and
the first engagement portion and the second engagement portion maintain the receiving slot in a closed state by engaging the first engagement portion and the second engagement portion with each other when the first housing part and the second housing part are biased into an engaged position.

3. The electrical connector housing according to claim 2, wherein the first engagement portion and the second engagement portion engage in a snap-fit manner.

4. The electrical connector housing according to claim 3, wherein one of the first engagement portion or the second engagement portion is a protruding block, and the other of the first engagement portion or the second engagement portion is an elastic sheet with an opening accommodating the protruding block.

5. The electrical connector housing according to claim 2, wherein one of the first engagement portion or the second engagement portion is an insert, and the other of the first engagement portion or the second engagement portion has a hole accommodating the insert.

6. The electrical connector housing according to claim 2, wherein:
the first housing part is provided with the first engagement portion on each of two sides of the receiving slot, respectively; and
the second housing part is correspondingly provided with the second engagement portion on each of the two sides of the receiving slot, respectively.

7. The electrical connector housing according to claim 6, wherein:
the first engagement portion is arranged proximate an entry of the receiving slot; and
the second engagement portion is arranged proximate the entry of the receiving slot.

8. The electrical connector housing according to claim 6, wherein:
the first engagement portion is integrally formed with the first housing part; and
the second engagement portion is integrally formed with the second housing part.

9. The electrical connector housing according to claim 1, wherein any one of the first housing part and the second housing part relative to the housing part provided with the receiving slot is formed with a locking block extending into the receiving slot, the locking block adapted to abut against the connection terminal placed into the receiving slot.

10. The electrical connector housing according to claim 9, wherein any one of the first housing part and the second housing part relative to the housing part provided with the receiving slot is formed with a locking notch, the locking notch adapted to permit the connection terminal placed into the receiving slot to extend thereinto and to abut against the connection terminal.

11. The electrical connector housing according to claim 1, wherein the first housing part and the second housing part are integrally formed with the elastic connection part.

12. An electrical connector, comprising:
an electrical connector housing, including:
a first housing part;
a second housing part, at least one of the first housing part and the second housing part defining a receiving slot; and
an elastic connection part connecting respective first ends of the first housing part and the second housing part, the elastic connection part adapted such that respective second ends of the first housing part and the second housing part opposite to the elastic connection part are separated from each other under an elastic action of the elastic connection part and the receiving slot is initially maintained in an open state; and
a plurality of connection terminals received within the receiving slot.

13. The electrical connector according to claim 12, further comprising a circuit board received within the receiving slot, the plurality of connection terminals and the circuit board are connected together and received into the receiving slot of the electrical connector housing as an assembly.

14. The electrical connector according to claim 13, wherein:
each connection terminal includes a crimping portion;
the first housing part of the electrical connector housing includes a locking block extending into the receiving slot; and
the crimping portion abuts against the locking block when the receiving slot is in a closed state.

15. The electrical connector according to claim 13, wherein:
each connection terminal comprises an elastic sheet portion;
the first housing part is formed with a locking notch;
when the receiving slot is in a closed state, at least a section of the elastic sheet portion extends into the locking notch, and an end of the elastic sheet portion abuts against the locking notch.

16. The electrical connector according to claim 13, wherein the plurality of connection terminals are engaged with the circuit board in a crimping manner.

17. The electrical connector according to claim 16, wherein the circuit board is a flexible printed circuit board.

18. An electrical connector housing, comprising:
a first housing part;
a second housing part, at least one of the first housing part and the second housing part defining a receiving slot adapted to receive a plurality of connection terminals and a circuit board; and
an elastic connection part connecting respective first ends of the first housing part and the second housing part, the elastic connection part biasing respective second ends of the first housing part and the second housing part opposite to the elastic connection part away from each other under an elastic action of the elastic connection part so as to place the receiving slot in an open state.

19. The electrical connector housing of claim 18, wherein the elastic connection part is a living hinge.

20. The electrical connector housing according to claim 18, wherein:
the first housing part includes a first engagement portion;
the second housing part includes a second engagement portion; and
the first engagement portion and the second engagement portion maintain the receiving slot in a closed state by engaging the first engagement portion and the second engagement portion with each other when the first housing part and the second housing part are biased into an engaged position.
